(19) United States
(12) Patent Application Publication
(10) Pub. No.: US 2026/0014750 A1
(43) Pub. Date: Jan. 15, 2026

(54) PLANT FOR PRODUCING AND TREATING CONTAINERS

(71) Applicant: Krones AG, Neutraubling (DE)

(72) Inventor: Christoph MICKO, Neutraubling (DE)

(21) Appl. No.: 19/266,503

(22) Filed: Jul. 11, 2025

(30) Foreign Application Priority Data
Jul. 12, 2024 (DE) 102024119901.6

(51) Int. Cl. B29C 49/00; B29C 49/42; B29C 49/64; B29C 49/78; B29L 31/00

(52) U.S. Cl. CPC B29C 49/006; B29C 49/42071; B29C 49/42808; B29C 49/6418; B29C 2049/7867; B29L 2031/712

(57) ABSTRACT

A plant for producing and treating containers includes a heating device having a plurality of heating elements for heating a preform transported through the heating device, a blow-molding machine downstream of the heating device for forming the preform into a container, and a container treatment machine downstream of the blow-molding machine for treating a container. The heating device, the blow-molding machine, and the container treatment machine are operable synchronously at different production speeds. The plant also includes a control unit which is configured to adjust a power of at least one of the heating elements depending upon a change in the production speed of the blow-molding machine or the container treatment machine such that a total heat quantity, supplied to a preform, in the heating device does not exceed a specified limit value.

### CROSS-REFERENCE TO RELATED APPLICATIONS

This application claims priority to, and the benefit of, German Patent Application No. 102024119901.6, filed Jul. 12, 2024, the contents of which are incorporated by reference herein in their entirety.

### TECHNICAL FIELD

The present invention relates to a plant for producing and treating containers and to a method for producing and treating containers using a plant for producing and treating containers.

### BACKGROUND

Plants for producing and treating containers are generally well known in the prior art. To optimize the treatment, block plants are also used in which a blow-molding machine for producing containers from preforms and a downstream treatment machine, in particular a filler, are interlocked with each other in terms of process technology, so that containers produced in the blow-molding machine are continuously transported to the treatment machine and can be further treated without interruption. This results in potential savings in the necessary treatment time.

However, it is necessary that the blow-molding machine and the container treatment machine be operated synchronously with each other, in particular with the same throughput or the same production speed, because, otherwise, idle running or undesirable accumulation of the containers may occur.

However, during operation, especially of fillers, necessary changes in production speed may occur due to process-related reasons—for example, if unintentional foaming occurs due to changes in the product with which containers are filled. In such cases, the production speed (especially the filler throughput) must be reduced.

From EP 3 668 697 B1, it is known to operate a container forming machine and a container filling machine synchronously at different production speeds, so that they can carry out container forming processes both at full production speed and at a first, reduced production speed.

However, due to the change in production speeds of the container forming machine and the container filling machine, deviations may occur in processes upstream of the preforms being formed into containers, particularly when heating or warming the preforms in a heating device, because, here too, the heating power acting upon the preforms is changed, which may have a detrimental effect on the production result of the containers.

### BRIEF SUMMARY

One aspect of the claimed invention relates to a plant and a method for producing and treating containers with which containers can be reliably produced and treated, even if the production speeds change.

A plant according to one embodiment of the invention for producing and treating containers comprises a heating device having a plurality of heating elements for heating a preform transported through the heating device, a blow-molding machine downstream of the heating device for forming the preform into a container, and a container treatment machine downstream of the blow-molding machine for treating a container, wherein the heating device, the blow-molding machine, and the container treatment machine are operable synchronously at different production speeds, wherein the plant further comprises a control unit which is configured to adjust a power of at least one of the heating elements depending upon a change in the production speed of the blow-molding machine or the container treatment machine such that a total heat quantity, supplied to a preform, in the heating device does not exceed a specified limit value.

Synchronous operation of the heating device, the blow-molding machine, and the container treatment machine at different production speeds means that the throughput of preforms and containers, i.e., the number of preforms heated in the heating device per unit of time and the number of containers produced or treated in the blow-molding machine and the container treatment machine per unit of time, is the same, so that the number of preforms fed to the heating device is equal to the number of containers produced by the blow-molding machine from the preforms and equal to the number of containers treated by the container treatment machine in the same period.

The power of at least one heating element is to be understood as an energy quantity and, in particular, a heat quantity applied to a preform. Infrared radiators, microwave radiators, lasers, or any other form of heating element can be provided as the heating element, wherein, in the sense of the invention, heating elements are provided whose output power can be controlled or regulated.

The specified limit value can, for example, be a maximum heat quantity that may be supplied to a preform so that it can be formed into a container according to specified production parameters and treated in a subsequent treatment step. This limit value can be, but does not necessarily have to be, independent of production speed and can be stored in the control unit—for example, in a data structure.

The control unit can be configured as a computer or central control unit of the plant and in particular comprise a processor and associated memory, wherein program instructions can be stored in the memory which, when executed by the processor, allow the control of the heating device, the blow-molding machine, and the container treatment plant according to the embodiments described here.

The invention is not limited with regard to the embodiment of the container treatment machine, wherein, however, an embodiment as a filler for filling a container produced in the blow-molding machine with product may be preferred, because reliable control of the temperature of the preforms may be advantageous, particularly in these cases.

The plant according to the invention can reliably ensure the production and treatment of containers even with changing production speeds.

It can be provided that the control unit be configured to adjust the power of the at least one heating element based upon a heat quantity already supplied to a preform transported in the heating device, so that the supplied heat quantity in the heating device does not exceed the specified limit value.

If the production speed is reduced while the preform has already been at least partially heated in the heating device, this embodiment can be used to adjust the power of subsequent heating elements in the transport direction so that they introduce less energy per unit of time into the preform in accordance with the reduced transport speed or production speed, so that only a total heat quantity is deposited in the preform that is overall less than the specified limit. This improves the treatment outcome.

It can be provided that the specified limit value be determined by a target heat quantity and a tolerance value.

The target heat quantity can, for example, be a production-speed-independent heat quantity that must be introduced into a preform so that said preform can be formed in the blow-molding machine and/or reliably treated in the container treatment machine. The target heat quantity can also be a minimum heat quantity. The tolerance value can, for example, be an absolute value in joules or kilojoules, or a percentage value which, together with the target heat quantity, indicates the limit value. For example, the limit value can be the target heat quantity plus a percentage of the target heat quantity, such as 10%, 15%, or 20%. The tolerance value can, for example, depend upon the changed production speed or upon the difference in production speeds. This provides flexibility in changing production speed, while maintaining tolerances for reliable container production and treatment.

In one embodiment, it is provided that the container treatment machine be a filler for filling a container with product and wherein the filler comprise a sensor for determining an operating parameter of the filler, wherein the control unit is configured to determine the change in the production speed depending upon a change in the operating parameter.

The operating parameter may, for example, be related to the product with which the container is to be filled or has been filled, or relate to a temperature of the container when being filled with product, or relate to a temperature of a product-carrying line or other component of the filler. Other realizations of the operating parameter, such as a carbon dioxide content of the product with which containers are to be filled, can also be provided. This embodiment allows the production speeds to be adjusted to requirements, in particular physical constraints, when the manufactured containers are being filled with product, which improves the reliable treatment of the manufactured containers.

The sensor may be a temperature sensor, and the operating parameter may be a product temperature in a product tank, a product-carrying line, a product distributor, and/or a filling valve.

By taking these operating parameters into account, foaming of the product and thus a reduction in the quality of the containers produced can be avoided by changing the production speeds.

The control unit may be configured to determine the change in production speed based upon the change in the operating parameter and a production characteristic of the filler and/or the blow-molding machine.

The characteristic curve can, for example, indicate at which production speed which product temperature or product temperatures is/are permissible in order to still achieve reliable filling of the containers with product. An inverse dependency or representation of the characteristic curve is also conceivable, i.e., at which product temperatures which production speed or speeds is/are permissible. By comparing the measured operating parameter to the production characteristic curve of the filler and/or blow-molding machine, it can then be determined how the production speed needs to be changed. This ensures that the containers are produced and reliably treated even when operating parameters change.

It can be provided that the control unit be configured, based upon a necessary change in the production speed, to block a supply of preforms to the heating device and to control a transport of preforms through the heating device and/or a transport of containers through the blow-molding machine and/or the container treatment machine, wherein the control unit is configured to change the production speed of the heating device, the blow-molding machine, and the container treatment machine when no preforms and containers are present in the heating device, the blow-molding machine, and the container treatment machine, and then to unblock the supply of preforms.

With this embodiment, the heating device, the blow-molding machine and the filler can first be run empty before the production speed and thus also the heating power are changed. This can reduce the control effort, but can lead to increased waste due to containers being rejected or to waste due to containers not being manufactured or treated correctly.

According to another aspect of the invention, a method for producing and treating containers using a plant for producing and treating containers is provided, the plant comprising a heating device having a plurality of heating elements for heating a preform transported through the heating device, a blow-molding machine downstream of the heating device for forming the preform into a container, and a container treatment machine downstream of the blow-molding machine for treating the container. The method comprises operating the heating device, the blow-molding machine, and the container treatment machine synchronously at different production speeds, and, with a control unit, adjusting a power of at least one of the heating elements depending upon a change in the production speed of the blow-molding machine or the container treatment machine such that a total heat quantity, supplied to a preform, in the heating device does not exceed a specified limit value.

This method allows for the reliable production and treatment of containers even with changing production speeds.

It can be provided that the control unit adjust the power of the at least one heating element based upon a heat quantity already supplied to a preform transported in the heating device, so that the supplied heat quantity in the heating device does not exceed the specified limit value. This allows for a more reliable adjustment of the power of at least the unit element.

In one embodiment, the method may further comprise, using the control unit, controlling the power of a preform, transported upstream of a preform in the heating device, depending upon the heat quantity already supplied and the changed production speed and a remaining residence time of the preform in the heating device or a remaining distance to be covered of the preform in the heating device, so that the supplied heat quantity in the heating device does not exceed the specified limit value.

With this embodiment, the power of the heating elements is reliably determined taking into account the production speed and the remaining distance or time of the preform in the heating device.

The specified limit value can be determined by a target heat quantity and a tolerance value. This ensures that an adjustment of the heating device's power the permissible heat quantity introduced into the preform is not exceeded.

The container treatment machine may be a filler for filling a container with product, and the filler may comprise a sensor for determining an operating parameter of the filler, wherein the control unit may determine the change in production speed depending upon a change in the operating parameter.

This allows any changes, particularly in the product and associated operating parameters of the filler, to be reliably taken into account, and thus the quality of the containers produced and filled can be improved.

The sensor may be a temperature sensor, and the operating parameter may be a product temperature in a product tank, a product-carrying line, a product distributor, and/or a filling valve.

Because the temperature of the product influences any foaming of the product, especially in the case of carbonated products, this allows a reliable response to a change in the product temperature.

It may be provided that the control unit determine the change in production speed based upon the change in the operating parameter and a production characteristic curve of the filler and/or the blow-molding machine. This embodiment allows a reliable adjustment of the production speed depending upon the change in the operating parameter.

In one embodiment, the method may further comprise, using the control unit and based upon a necessary change in the production speed, blocking a supply of preforms to the heating device and controlling a transport of preforms through the heating device and/or a transport of containers through the blow-molding machine and/or the container treatment machine, wherein the control unit changes the production speed of the heating device, the blow-molding machine, and the container treatment machine when no preforms and containers are present in the heating device, the blow-molding machine, and the container treatment machine, and then unblocks the supply of preforms. With this embodiment, the control effort required when changing the production speed can be reduced.

### BRIEF DESCRIPTION OF THE FIGURES

FIG. 1 shows a schematic view of a plant for producing and treating a container according to an embodiment.

FIG. 2 shows a flowchart of a method for producing and treating a container according to an embodiment.

FIG. 3 schematically shows a course of the temperature of individual heating elements depending upon their position in the heating device with changing production speed.

### DETAILED DESCRIPTION

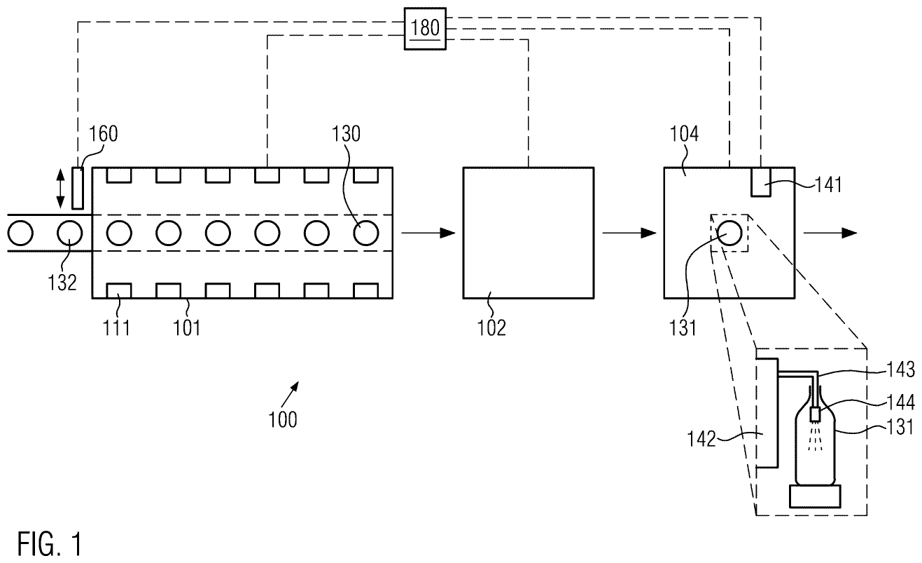

FIG. 1 shows a schematic view of a plant for producing and treating containers according to an embodiment of the invention.

The plant comprises a heating device 101, which comprises a plurality of heating elements 111. Preferably, the heating elements are separately controllable and, in particular, separately adjustable with regard to their output power and are configured to heat a preform 130 introduced into the heating device and transported through the heating device, in particular to deposit a heat quantity in the preform. In principle, the heating elements can be configured in any way. However, preferred embodiments are those which allow the power output of the respective heating elements to be changed at the shortest possible intervals. These include, for example, infrared or microwave heating elements as well as heating elements that use lasers.

According to the invention, a blow-molding machine 102 is arranged downstream of the heating device 101, which can take over the preforms heated in the heating device and form containers from them in a known manner by the action of blowing pressure and optionally by stretching the preforms by means of a stretching rod along their longitudinal axis.

The invention is not limited with regard to the embodiment of the blow-molding machine 102. However, it may be advantageous if the blow-molding machine is configured as a carousel which comprises a plurality of blow-molds along its periphery, into each of which a preform can be introduced in order to form it into a container. The transfer of the preforms to the blow-molding machine can take place either directly, i.e., without further transport devices between the heating device and the blow-molding machine, or by transferring the preforms to one or more transport devices, e.g., known rotary stars, which remove the preforms from the heating device and transport them to the blow-molding machine and transfer them thereto.

Downstream of the blow-molding machine, a container treatment machine 104 is arranged in which the containers produced in the blow-molding machine 102 can be treated. The container treatment machine 104 is in principle not limited as to its embodiment and can be configured, for example, as a labeling machine or filler or a combination of a filler and a closer. Analogously to the blow-molding machine, the container treatment machine can be, but does not have to be, configured as a carousel having a plurality of container holders or treatment stations on the periphery of the carousel.

It can be provided that the transfer of the containers produced in the blow-molding machine 102 take place either directly to the container treatment machine without further transport devices or via further transport devices such as conveyor belts and/or one or more rotary stars. It is preferably provided that, at least between the blow-molding machine and the container treatment machine, no intermediate storage of containers take place for an indefinite period of time, in particular in a disordered manner, so that a container which has been produced in the blow-molding machine is fed directly to the container treatment machine. Immediate supply is understood to mean a supply that is delayed by no more than the necessary transport time from the blow-molding machine to the container treatment machine.

According to the invention, it is provided that both the blow-molding machine 102 and the container treatment machine 104 be able to be operated at different production speeds (at least a first and a second production speed). The production speed is defined as the throughput of the containers, i.e., the number of containers that are processed by the relevant machine per unit of time. A change in production speed from a first to a second production speed may, but does not have to, involve a change in the speed at which the treatment process in the container treatment machine or the blow-molding process in the blow-molding machine is carried out. A change in throughput can also be achieved, for example, by carrying out the respective treatment steps in the blow-molding machine and the container treatment machine at the same time, but by reducing or increasing the transport speed of the containers in the respective machines.

According to the invention, the plant 100 further comprises a control unit 180 which is connected at least to the heating device 101, the blow-molding machine 102, and the container treatment machine 104 for the purpose of data exchange and for the transmission of control or regulating signals. The control unit 180 can be configured in particular as a computer with a processor and associated memory. According to the invention, it is provided that the control unit 180 be configured to control the heating device 101 and in particular at least one heating element 111 of the heating device when the production speed of the blow-molding machine or the container treatment machine or both changes, such that the power of the at least one heating element 111 is adjusted depending upon the change in the production speed of the blow-molding machine and/or the container treatment machine such that the total heat quantity, supplied to a preform, in the heating device does not exceed a specified limit value.

This means, for example, that, if the production speed of the blow-molding machine and/or the container treatment machine is reduced, the transport speed of the preforms through the heating device must also be reduced accordingly. This extends the residence time of the preforms in the heating device, and, if the power of the heating elements were not adjusted, they would receive more heat energy from the heating elements than is necessary or permissible for forming the preforms into containers. For this reason, in one embodiment, it is provided that, when the production speed is reduced, the control unit 180 reduce the power of at least one of the heating elements, and when the production speed is increased, the power of at least one of the heating elements be increased.

The increase or decrease in power is selected in such a way that at least a heat quantity that may be supplied to a preform in order to nevertheless allow reliable forming of the preform into a container does not exceed a maximum, and/or a required heat quantity that must be supplied to the preform in order to ensure that the preform is formed into a container does not fall below a minimum. These maximum and minimum values can also be called limit values.

However, it can also be provided that the total heat quantity supplied to the preform be selected by regulating the power of the heating elements by the control unit in such a way that it not only does not exceed the limit value, but also does not fall below a second limit value that, for example, defines a minimum heat quantity supplied to a preform which allows the preform to be formed into a container in the blow-molding machine.

The limit value or the limit values can be defined, for example, by a target heat quantity, in kilojoules or joules, and a tolerance value. The target heat quantity can, for example, be the heat quantity that is deposited in the preform under ideal production conditions in order to heat it appropriately for forming in the blow-molding machine. The tolerance value can be an absolute or percentage value that can be added to the target heat quantity to define the maximum supplied heat quantity as a limit value. If a second limit value is provided, as described above, a corresponding tolerance value can also be deducted from the target heat quantity, so that a range around the target value can be determined in which a supply of heat in the heating device is permissible, in order to allow the preform to be formed into a container.

This ensures that, when the production speed of a machine arranged downstream of the heating device changes, in particular the container treatment machine or the blow-molding machine, an excessive heat quantity is not deposited in the preform, and its temperature therefore does not rise above the temperature permissible for blow-molding.

In FIG. 1, the container treatment machine 104 is configured as a filler, for example. A change in the production speed may be necessary, particularly in embodiments of the invention in which the container treatment machine is configured as such a filler. When a filler is in operation, the components of the filler heat up due to heat transfer from the container to the filler, but also due to friction and other internal processes in the filler. This can also affect a product with which the filler is to fill the container. If, for example, the products in question are carbonated, such as beverages, this can lead to the product overflowing in the container during filling, which can result in product spillage and thus contamination of the container treatment machine and possibly insufficient filling of the particular container. To prevent this foaming, it may be necessary to reduce the production speed of the filler. According to the invention, the production speed of the blow-molding machine is then also reduced, and, as described above, the power of at least one or of the heating elements of the heating device is adjusted.

A change in production speed can, in principle, have any cause. For example, an operator can specify that the production speed is to be reduced or increased. However, in some embodiments, it is provided that a change in the production speed be required, desirable, or necessary, in particular, due to changing operating parameters in the container treatment machine, such as a filler.

In order to be able to detect this in a timely manner, the container treatment machine 104 can comprise a sensor 141 which can determine an operating parameter of the container treatment machine. The control unit 180 may be configured to receive the operating parameter of the sensor and to determine a change in the production speed depending upon the change in the operating parameter.

Using the example of a filler as a container treatment machine 104, FIG. 1 shows by way of example that the filler comprises a product tank 142 for product with which to fill containers, as well as a product-carrying line 143 and a filling valve 144. From the product tank 142, the product flows into the product-carrying line 143 and from there into the filling valve 144, from whence the container 131 is filled with product, as shown. The filler may also comprise further product-carrying lines or, in particular, distributors for product starting from the product tank 142, which lines, however, are not shown here.

In one embodiment, it is provided that the sensor 141 of the filler be able to measure a temperature of the product transported in the product tank 142 and/or the product-carrying line 143 and/or the filling valve 144, and/or be able to measure a temperature of the product tank and/or a temperature of the product-carrying line and/or a temperature of the filling valve 144 itself and be able to transmit this to the control unit 180. Any combination of these is also conceivable.

The control unit 180 can then determine—for example, by comparing the measured temperature, or generally an operating parameter, to a target value—whether a change in the production speed is necessary and, if so, redetermine the production speed and then, as already described, adjust the production speed of the treatment machine and the blow-molding machine and control the power of the heating device or at least one heating element of the heating device.

Because a change in the value of an operating parameter may require a non-linear change in the production speed, i.e., the production speed is not linearly related to the value of the operating parameter, it may be provided that a production characteristic curve of the filler and/or the blow-molding machine be stored in a memory of the control unit 180. This production characteristic curve may define a functional, in particular numerical, relationship between a value of a specific operating parameter, such as the temperature of the product, and the production speed necessary or permissible for this value of the operating parameter. The production characteristic curve does not have to be stored as a function in the memory of the control unit, but may also be stored, for a plurality of possible values of operating parameters and associated production speeds, in the form of a lookup table, LUT, which makes it possible to easily determine the necessary production speed and in particular the change in the production speed when the value of the operating parameter is known, and to effect this by means of the control unit.

It is preferably provided that an adjustment of the power of the heating elements 111 be generally carried out in such a way that also preforms already present in the heating device 101, which have already experienced a certain input of heat, are exposed, after a reduction in the production speed, only to a heat quantity which is below the specified limit value and/or above a minimum limit value already described. When not exceeding a limit value is described below, this means both not exceeding a maximum limit value and not falling below a minimum limit value.

This can be achieved by reducing the power of the heating elements downstream of a given preform in the transport direction. The heat quantity required to be introduced for each preform remaining in the container treatment machine depends upon the position of the preform, and it is therefore possible to determine how the heating power of each of the heating elements must be changed in order to ensure, as far as possible, that each preform still remaining in the heating device receives only a heat quantity input which is at least below the limit value.

However, alternatively or additionally, it may also be provided that the plant comprise a blocking element 160 which can prevent the supply of preforms 132 to the heating device 101. If the control unit 180 determines that, for example, a change in the production speed is necessary due to a change in an operating parameter, the control unit 180 can actuate the blocking element 160 in order to suppress the supply of preforms 132 to the heating device. The remaining preforms in the heating device can either be further heated by adjusting the power of one or more of the heating elements according to the above explanations and fed to the blow-molding machine 102, and then treated in the container treatment machine 104, or it can be provided that the heating device 101 be run empty and the preforms not be further processed into containers, or at least the containers made from the preforms not be treated in the container treatment machine. This can be particularly advantageous if the container treatment machine 104 is configured as a filler and an adjustment of the heating power is not possible in such a way that a reliable filling of the containers can be ensured and/or a control of the production speed of the filler cannot be carried out quickly enough to ensure a reliable filling of immediately subsequent containers.

Thereafter, the feed can be blocked and the production speed of the blow-molding machine 102 and the container treatment machine 104 can be adjusted, and, analogously, the heating power of the at least one heating element of the heating device 101 can be adjusted. Subsequently, the supply of preforms to the heating device can be unblocked again by actuating the blocking element 160, and operation can be continued at the reduced or changed production speed.

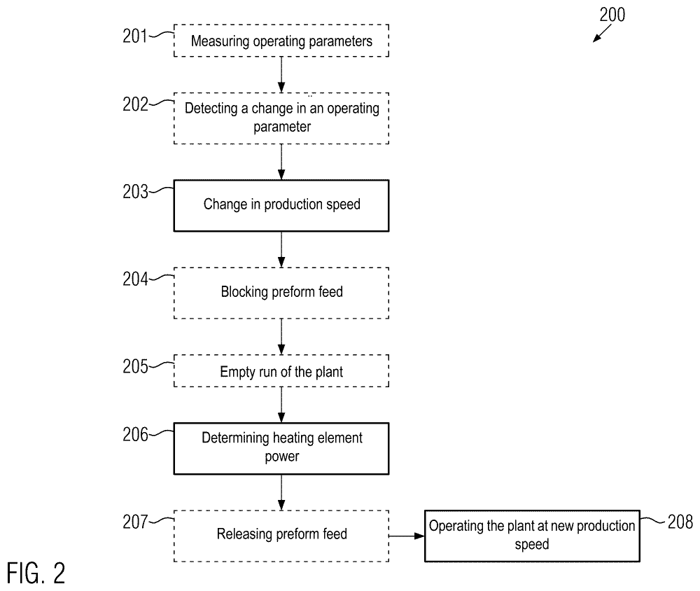

FIG. 2 shows a flowchart of a method 200 according to an embodiment with which it is possible to operate the plant at varying production speeds.

The method 200 begins with two optional steps 201 and 202, wherein, in step 201, a preferably continuous measurement of the operating parameter, such as the product temperature in the product tank, is carried out. If it is determined that the value of the operating parameter changes beyond a permissible tolerance value 202, the control unit can determine in step 203 how the production speed of the container treatment machine and the blow-molding machine needs to be adjusted. This can be done, for example, using the production characteristic curve already described.

Subsequently or based thereon, a necessary change or a new value of the power of at least one heating element can then be determined in step 206. The control unit can then adjust the transport of the containers through the blow-molding machine and the container treatment machine according to the new production speed by controlling the drives of the transport devices, such as the carousel of the relevant machine, and by adjusting the power of the heating elements in step 208, allow the plant to be operated at the new production speed without the operation of the plant having to be interrupted or preforms or containers having to be ejected.

As already described, however, it can optionally also be provided that the preform feed be blocked in step 204, and then the entire plant or at least the heating device be emptied in step 205, and only when the necessary change in the production speed in step 203 and the necessary change in the power of the heating element(s) in step 206 has taken place can the feed of preforms be unblocked again, so that new preforms are only fed to the heating device and the blow-molding machine as well as the container treatment machine when the production speed of the blow-molding machine and the container treatment machine has already been adjusted, and the power of the heating elements has also been adjusted in accordance with the changed production speed.

The placement of the optional steps 204 and 205 between the determination of the change in production speed and the determination of the changed power of the heating elements is not mandatory. It can also be provided that steps 204 and 205 take place directly after the detection of a change in an operating parameter, which in principle requires a change in the production speed, and that the changed production speed and the changed heating power then be determined during the empty run in accordance with steps 203 and 206. However, the unblocking of the supply of preforms preferably takes place in step 207 only after the production speed of the blow-molding machine and the container treatment machine has been adjusted to the new value, and the heating power of the heating elements has also been adjusted to the new value.

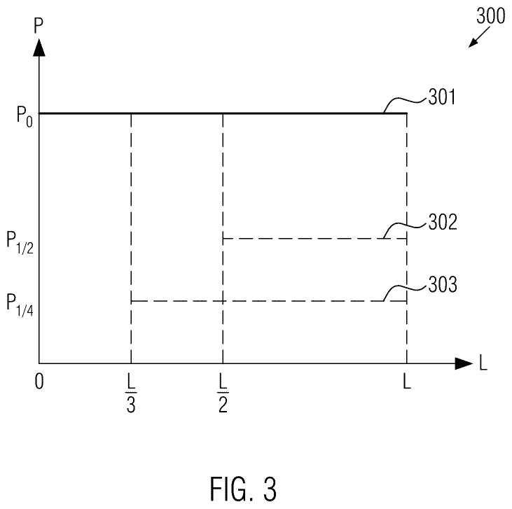

FIG. 3 shows schematically the power P of heating elements depending upon their position along the length L of the heating device. The illustration is not limited to the heating device being configured as a linear heating device, such as an elongated furnace, through which the preforms are guided along exactly one direction. The length L is, rather, the course traveled by the preforms in the heating device. The length L does not have to be the total length of the heating device, but represents a measure of the distance along which the preforms can actually be heated by heating elements. For example, if the heating device comprises a 1 m long feed region for transferring the preforms to the heating device and a 1 m long transfer region for transferring the heated preforms to a downstream device and has a total length G, and no heating elements are arranged in these regions, the length L can, for example, be G−2 m.

While the functions shown here for the power P along the course traveled are shown as continuous, it is understood that these are usually only defined in portions, viz., in a particular region of a heating element, and will therefore have a rather discontinuous character. However, in the simplified representation, consistent functions were used.

The illustration shows a first curve 301 in which the power of all heating elements is constant along the path L traveled by the preforms from the beginning of the heating device (or from the beginning of the heating elements, as discussed above) at point 0 up to the length L. This curve is to serve as a starting point for the following discussion, wherein a constant value of the power P₀ of all heating elements over the entire length of the heating device is only to be understood as an example. It can also be provided that, at a given speed, e.g., the normal production speed, the power of the heating elements already vary along the length of the heating device—for example, in order to heat the preforms initially slightly and then increasingly faster. In such a case, the curve 301 would, for example, start at a lower value at point 0 when the heating device starts and grow up until the length L. Other embodiments are also conceivable in which the heating power increases from the beginning of the heating device to a maximum and decreases again until the end of the heating device.

FIG. 3 shows a first case in which a preform has already passed half the length L/2 of the heating device, and the production speed has then been reduced to half of the original value. This means that the transport speed of the preform in the heating device must also be reduced by half to avoid a build-up of preforms. If the power of the heating elements past which the preform is transported on the way from position L/2 to L were to remain unchanged, the preform would experience a higher input of heat due to the lower transport speed at the same power. To prevent this, one embodiment provides that in this case the power of the heating elements upstream of the preform, i.e., starting at L/2 up to the end of the heating device at L, be reduced to half P_{1/2}, as shown by curve 302.

Analogously, this provision applies if a preform has already passed one-third of the path in the heating device L/3, and the production speed is reduced from the initial value to one-quarter. This also quadruples the residence time of the preform in the remaining two-thirds of the furnace, so that the throughput is adjusted to the reduced production speed. Accordingly, the power of the heating devices must be reduced from L/3 to L to a quarter, i.e., P_{1/4}, as shown in graph 303.

Assuming that the heating elements are adjustable in their power without time delay and without cooling time, these exemplary embodiments would ensure, by reducing the output power of all heating elements by a suitable factor for any preform currently located in the heating device, that its total heat quantity recorded is exactly equal to the heat quantity recorded of the reference production speed according to curve 301.

However, this is not necessarily the case, since, for example, cooling the heating elements may be necessary if the output power is reduced. Such a cooling process requires a certain amount of time, which means that the output power of the heating elements may not be able to be adjusted instantaneously, i.e., without a time delay, from a first value to a second value. This can be taken into account by considering a limit value for the heating power introduced into the preform, which, as described above, can include a tolerance value above a target heat quantity until heating of the preform is still permissible.

The control unit can then, taking into account, for example, suitable models for the heating behavior of the heating elements when changing the heating power, determine how each heating element must be controlled to ensure that all preforms remaining in the heating device experience an input of heat that does not exceed the limit value. If it is determined that this cannot be ensured due to the technical constraints of the heating elements, an output can be made on an operator terminal, for example, and/or it can be provided that the feed of preforms into the heating device be blocked (as described in connection with FIGS. 1 and 2) and that, initially, no further heating of the preforms or processing of the preforms into containers take place and the preforms that cannot be subjected to the heat quantity below the limit value be discharged from the heating device or after leaving the heating device. Subsequent preforms can then be fed back into the heating device after the heating elements have been adjusted to the required heating power.

What is claimed is:

1. A plant for producing and treating containers, the plant comprising:
a heating device having a plurality of heating elements for heating a preform transported through the heating device,
a blow-molding machine downstream of the heating device for forming the preform into a container, and
a container treatment machine downstream of the blow-molding machine for treating a container,
wherein the heating device, the blow-molding machine, and the container treatment machine are operable synchronously at different production speeds, and
wherein the plant further comprises a control unit which is configured to adjust a power of at least one of the heating elements depending upon a change in the production speed of the blow-molding machine or the container treatment machine such that a total heat quantity, supplied to a preform, in the heating device does not exceed a specified limit value.

2. The plant according to claim 1, wherein the control unit is configured to adjust the power of the at least one heating element based upon a heat quantity already supplied to a preform transported in the heating device, so that the supplied heat quantity in the heating device does not exceed the specified limit value.

3. The plant according to claim 1, wherein the specified limit value is determined by a target heat quantity and a tolerance value.

4. The plant according to claim 1, wherein the container treatment machine is a filler for filling a container with a product and wherein the filler comprises a sensor for determining an operating parameter of the filler, wherein the control unit is configured to determine the change in the production speed depending upon a change in the operating parameter.

5. The plant according to claim 4, wherein the sensor is a temperature sensor and wherein the operating parameter is a product temperature in a product tank, a product-carrying line, a product distributor, and/or a filling valve.

6. The plant according to claim 5, wherein the control unit is configured to determine the change in the production speed based upon the change in the operating parameter and a production characteristic of the filler and/or the blow-molding machine.

7. The plant according to claim 1, wherein the control unit is configured, based upon a necessary change in the production speed, to block a supply of preforms to the heating device and to control a transport of preforms through the heating device and/or a transport of containers through the blow-molding machine and/or the container treatment machine, wherein the control unit is configured to change the production speed of the heating device, the blow-molding machine, and the container treatment machine when no preforms and containers are present in the heating device, the blow-molding machine, and the container treatment machine, and subsequently to unblock the supply of preforms.

8. A method for producing and treating containers using a plant for producing and treating containers, the plant including a heating device having a plurality of heating elements for heating a preform transported through the heating device, a blow-molding machine downstream of the heating device for forming the preform into a container, and a container treatment machine downstream of the blow-molding machine for treating the container, the method comprising:
operating the heating device, the blow-molding machine, and the container treatment machine synchronously at different production speeds; and
using a control unit, adjusting a power of at least one of the heating elements depending upon a change in the production speed of the blow-molding machine or the container treatment machine such that a total heat quantity, supplied to a preform, in the heating device does not exceed a specified limit value.

9. The method according to claim 8, wherein the control unit adjusts the power of the at least one heating element based upon a heat quantity already supplied to a preform transported in the heating device, so that the supplied heat quantity in the heating device does not exceed the specified limit value.

10. The method according to claim 9, further comprising, using the control unit, controlling the power of a preform, transported upstream of a preform in the heating device, depending upon the heat quantity already supplied and the changed production speed and a remaining residence time of the preform in the heating device or a remaining distance of the preform in the heating device, so that the supplied heat quantity in the heating device does not exceed the specified limit value.

11. The method according to claim 8, wherein the specified limit value is determined by a target heat quantity and a tolerance value.

12. The method according to claim 8, wherein the container treatment machine is a filler for filling a container with product and wherein the filler comprises a sensor for determining an operating parameter of the filler, wherein the control unit determines the change in the production speed depending upon a change in the operating parameter.

13. The method according to claim 12, wherein the sensor is a temperature sensor and wherein the operating parameter is a product temperature in a product tank, a product-carrying line, a product distributor, and/or a filling valve.

14. The method according to claim 12, further comprising determining, with the control unit, the change in the production speed based upon the change in the operating parameter and a production characteristic of the filler and/or the blow-molding machine.

15. The method according to claim 8, further comprising
using the control unit and based upon a necessary change in the production speed, blocking a supply of preforms to the heating device and controlling a transport of preforms through the heating device and/or a transport of containers through the blow-molding machine and/or the container treatment machine,
wherein the control unit changes the production speed of the heating device, the blow-molding machine, and the container treatment machine when no preforms and containers are present in the heating device, the blow-molding machine, and the container treatment machine, and then unblocks the supply of preforms.
